(19) United States
(12) Patent Application Publication
(10) Pub. No.: US 2026/0221618 A1
(43) Pub. Date: Jul. 30, 2026

(54) ELECTRODE ASSEMBLY, SECONDARY BATTERY, AND METHOD FOR MANUFACTURING SAME

(71) Applicant: SAMSUNG SDI CO., LTD., Yongin-si (KR)

(72) Inventor: Taewoong JANG, Yongin-si (KR)

(21) Appl. No.: 19/266,607

(22) Filed: Jul. 11, 2025

(30) Foreign Application Priority Data
Jan. 24, 2025 (KR) 10-2025-0011428

(51) Int. Cl. H01M 50/538; H01M 4/04; H01M 10/0525; H01M 10/0587; H01M 50/107; H01M 50/152; H01M 50/595

(52) U.S. Cl. CPC H01M 50/538; H01M 4/0435; H01M 10/0525; H01M 10/0587; H01M 50/107; H01M 50/152; H01M 50/595

(57) ABSTRACT

An electrode assembly includes a first electrode having a first electrode tab connected thereto, a second electrode having a second electrode tab connected thereto, and a separator between the first electrode and the second electrode, wherein the first electrode, the separator, and the second electrode are sequentially stacked and wound, and wherein a thickness of a distal end of a leading end of the first electrode is thinner than a thickness of a portion of the first electrode excluding the distal end of the leading end, the distal end being in a core part when the first electrode is wound.

### CROSS-REFERENCE TO RELATED APPLICATION

This application claims priority under 35 U.S.C. § 119 to Korean Patent Application No. 10-2025-0011428, filed in the Korean Intellectual Property Office on Jan. 24, 2025, the entire contents of which are hereby incorporated by reference.

### BACKGROUND

### 1. Field

The present disclosure relates to an electrode assembly, a secondary battery including the electrode assembly, and a method for manufacturing the secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, a lithium secondary battery is manufactured by inserting, into a case, an electrode assembly obtained by disposing a separator between a positive electrode and a negative electrode and then winding or stacking the separator and the electrodes in sequence.

The above information disclosed in this Background section is for enhancement of understanding of the background of the present disclosure, and therefore, it may contain information that does not constitute related (or prior) art.

### SUMMARY

Embodiments are directed to an electrode assembly, including a first electrode having a first electrode tab connected thereto, a second electrode having a second electrode tab connected thereto, and a separator between the first electrode and the second electrode, wherein the first electrode, the separator, and the second electrode are sequentially stacked and wound, and wherein a thickness of a distal end of a leading end of the first electrode is thinner than a thickness of a portion of the first electrode excluding the distal end of the leading end, the distal end being in a core part when the first electrode is wound.

The electrode assembly may further include a protective tape on the distal end of the leading end, wherein the protective tape wraps at least a part of the distal end of the leading end in a direction perpendicular to a lengthwise direction of the first electrode.

The distal end of the leading end may be flattened.

A thickness of a distal end of a trailing end of the first electrode on an outer circumference of the electrode assembly may be thinner than a thickness of a portion of the first electrode excluding the distal end of the trailing end.

The electrode assembly may further include a protective tape on the distal end of the trailing end, wherein the protective tape wraps at least a part of the distal end of the trailing end in a direction perpendicular to a lengthwise direction of the first electrode.

The distal end of the trailing end may be flattened.

The first electrode may include a substrate layer and an active material layer coated on at least one surface of the substrate layer, and a non-coated portion where the active material layer is not coated is at the distal end of the leading end of the substrate layer.

A thickness of the distal end of the leading end of the substrate layer having the non coated portion may be thinner than a thickness of a portion of the substrate layer other than the non coated portion.

The electrode assembly may further include a protective tape on the distal end of the leading end of the substrate layer having the non coated portion, wherein the protective tape wraps the distal end of the leading end of the substrate layer having the non coated portion in a direction perpendicular to a lengthwise direction of the first electrode.

The first electrode may include a substrate layer and an active material layer coated on at least one surface of the substrate layer, and a non-coated portion where the active material layer is not coated is at the distal end of the trailing end of the substrate layer.

A thickness of the distal end of the trailing end of the substrate layer having the non coated portion may be thinner than a thickness of a portion of the substrate layer other than the non coated portion.

The electrode assembly may further include a protective tape at the distal end of the trailing end of the substrate layer where the non-coated portion is formed, wherein the protective tape wraps around the distal end of the trailing end of the substrate layer with the non-coated portion in a direction perpendicular to a lengthwise direction of the first electrode.

Embodiments are direct to a secondary battery, including an electrode assembly having a winding of a first electrode, a second electrode, and a separator between the first electrode and the second electrode, a cylindrical case including a bottom portion, a sidewall portion connected to the bottom portion, and an opening opposite the bottom portion, the cylindrical case accommodating the electrode assembly, and a cap assembly coupled to one end of the sidewall portion of the case to seal the opening, wherein a thickness of a distal end of a leading end of the first electrode in a core part of the electrode assembly in a state in which the electrode assembly is wound is thinner than a thickness of a portion of the first electrode excluding the distal end of the leading end.

A thickness of a distal end of a trailing end of the first electrode on an outer circumference of the electrode assembly may be thinner than a thickness of a portion of the first electrode excluding the distal end of the trailing end.

The secondary battery may further include a protective tape on at least one of the distal end of the leading end and the distal end of the trailing end, wherein the protective tape wraps at least one of the distal end of the leading end and the distal end of the trailing end in a direction perpendicular to a lengthwise direction of the first electrode.

The first electrode may include a substrate layer and an active material layer coated on at least one surface of the substrate layer, at least one of the distal end of the leading end and the distal end of the trailing end of the substrate layer includes a non-coated portion where the active material layer is not coated, and a thickness of at least one of the distal end of the leading end and the distal end of the trailing end of the substrate layer having the non-coated portion is thinner than a thickness of a portion of the substrate layer other than the non-coated portion.

Embodiments are directed to a method for manufacturing a secondary battery, the method including pressing, among electrode plates supplied by roll to roll equipment, a portion corresponding to at least one of a distal end of a leading end and a distal end of a trailing end of a first electrode, attaching a protective tape to at least one of the distal end of the leading end and the distal end of the trailing end among the electrode plates, cutting, among the electrode plates, a portion corresponding to a region between the distal end of the leading end and the distal end of the trailing end, preparing an electrode assembly formed by winding the first electrode, a second electrode, and a separator interposed between the first electrode and the second electrode, preparing a cylindrical case including a bottom portion, a sidewall portion connected to the bottom portion, and an opening opposite the bottom portion, inserting the electrode assembly into the case, and coupling the case and a cap assembly to seal the opening.

The pressing may include pressing at least one of the distal end of the leading end and the distal end of the trailing end in a direction perpendicular to one surface of the first electrode.

The attaching may include wrapping the protective tape around at least one of the distal end of the leading end and the distal end of the trailing end in a direction perpendicular to a lengthwise direction of the first electrode.

The first electrode may include a substrate layer and an active material layer coated on at least one surface of the substrate layer, at least one of the distal end of the leading end and the distal end of the trailing end of the substrate layer may include a non coated portion where the active material layer is not coated, and the pressing may include pressing a distal end of the non coated portion in a direction perpendicular to one surface of the first electrode.

These and other aspects and features of the present disclosure will be described in, or will be apparent from, the following description of embodiments of the present disclosure.

However, aspects and features of the present disclosure are not limited to those described above, and other aspects and features not mentioned will be clearly understood by a person skilled in the art from the detailed description described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

Features will become apparent to those of ordinary skill in the art by describing in detail exemplary embodiments with reference to the attached drawings, in which:

FIG. 1 is a cross-sectional view illustrating a secondary battery according to an embodiment of the present disclosure;

FIG. 2 illustrates a state after winding of an electrode assembly according to an embodiment of the present disclosure;

FIG. 3 illustrates a first electrode according to an embodiment of the present disclosure;

FIG. 4 illustrates a state before cutting of the first electrode according to an embodiment of the present disclosure;

FIG. 5 illustrates a state before cutting of a leading portion and a trailing portion according to an embodiment of the present disclosure;

FIG. 6 illustrates a state after cutting of the first electrode according to an embodiment of the present disclosure;

FIG. 7 is a diagram illustrating a press process of the first electrode according to an embodiment of the present disclosure;

FIG. 8 is a diagram illustrating a press process of the first electrode according to an embodiment of the present disclosure; and

FIG. 9 illustrates an example of a method for manufacturing a secondary battery according to an embodiment of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Hereinafter, embodiments of the present disclosure will be described in detail with reference to the accompanying drawings. The terms or words used in the present specification and claims are not to be limitedly interpreted as general or dictionary meanings and should be interpreted as meanings and concepts that are consistent with the technical idea of the present disclosure on the basis that an inventor may be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that various equivalents and modifications that can replace or modify the embodiments described herein may be present at the time of filing this application.

Also, it will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, in the figures, dimensions of various elements, layers, and the like may be exaggerated for clarity of illustration. The same reference numerals designate the same elements.

References to two compared elements or features as being “the same” may mean that they are “substantially the same.” Thus, the phrase “substantially the same” may include a case having a deviation that is considered small in the art, for example, a deviation of 5 percent or less. In addition, when a certain parameter is referred to as being uniform in a given region, it may mean that it is uniform in terms of an average.

It will be understood that, although the terms first, second, and the like may be used herein to describe various elements, these elements should not be limited by these terms. These terms are only used to distinguish one element from another element. Thus, a first element could be termed a second element unless the context clearly indicates otherwise.

Throughout the specification, unless otherwise stated, each element may be singular or plural.

Arranging an arbitrary element “above” (or “below”) or “on” (“under”) another element may mean that the arbitrary element is disposed in contact with an upper (or lower) surface of the element, and another element may also be interposed between the element and the arbitrary element disposed on (or under) the element.

In addition, it will be understood that when a component is referred to as being “linked,” “coupled,” or “connected” to another component, the components may be directly “linked,” “coupled,” or “connected” to each other, or another component may be “interposed” between the components. It will also be understood that when an element is referred to as being “electrically coupled” to another element, it may be directly coupled to the other element or intervening elements may be present.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

In the present disclosure, sizes and relative sizes of regions shown in the drawings may be exaggerated for clarity of description. That is, the sizes shown in the drawings are merely for convenience of understanding and are not limited.

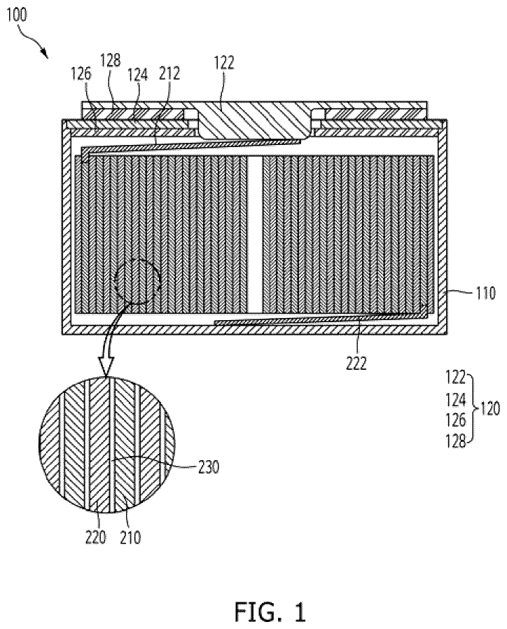

FIG. 1 is a cross-sectional view illustrating a secondary battery according to an embodiment of the present disclosure.

In the present disclosure, the secondary battery 100 may refer to a secondary battery including a wound-type electrode assembly. For example, the secondary battery 100 may be a coin-type cell, a cylindrical cell, or a pin-type cell, but may vary. Hereinafter, a case in which the secondary battery 100 is an ultraminiature battery, specifically a coin-type cell, will be described as an example.

Here, a coin-type cell or a button-type cell is a battery in the form of a thin coin or button and may mean a battery having a ratio of height to diameter (height/diameter) of 1 or less, but the ratio may vary. A coin-type cell or a button-type cell is mainly cylindrical, so a cross-section in a horizontal direction is circular, but a cross-section in a horizontal direction that is elliptical or polygonal may also be included. In this case, the diameter may mean a maximum distance based on the horizontal direction of the battery, and the height may mean a maximum distance based on the vertical direction of the battery (the distance from a flat bottom surface to a flat top surface).

Referring to FIG. 1, the secondary battery 100 may include an electrode assembly, a case 110 accommodating the electrode assembly and an electrolyte therein, and a cap assembly 120 coupled to an opening of the case 110 to seal the case 110. The cap assembly 120 may include a cap plate 124 coupled to the opening of the case 110, a terminal plate 122 insulated from the cap plate 124, an insulating layer 128 insulating the terminal plate 122 from the cap plate 124, and an insulating member 126 positioned between the electrode assembly and the cap plate 124 inside the case 110.

In an embodiment, the case 110 accommodates the electrode assembly and the electrolyte and constitutes an external appearance of the secondary battery together with the cap assembly 120. The case 110 may include a sidewall portion having an approximately cylindrical shape and a bottom portion connected to one end of the sidewall portion. However, the case 110 may have various shapes such as circular or polygonal.

In addition, the case 110 may be formed of a metal such as aluminum, an aluminum alloy, nickel-plated steel, or stainless steel (SUS). However, the material of the case 110 may vary, as long as it is a material having chemical resistance to the electrolyte and having conductivity and is commonly used in the art.

The terminal plate 122 may be electrically connected to the electrode assembly. The terminal plate 122 may be physically connected to the electrode assembly through the first electrode tab 212 or the like. The terminal plate 122 may be electrically insulated from the cap plate 124 through the insulating layer 128. In addition, the terminal plate 122 may be adhered to the cap plate 124 through the insulating layer 128. Accordingly, the terminal plate 122 may function as an electrode terminal. Referring to FIG. 1, the terminal plate 122 may include a protruding portion at a lower side and a flange portion at an upper side, and the protruding portion may be inserted into an opening formed in the center of the cap plate 124. In addition, the insulating member 126 may be disposed such that the electrode assembly or the first electrode tab 212 connected to the electrode assembly is insulated from the cap plate 124. For example, as shown in FIG. 1, the first electrode tab 212 of the electrode assembly may contact the protruding portion of the terminal plate 122. Therefore, the insulating member 126 may be disposed between the cap plate 124 and the electrode assembly except for a portion where the protruding portion of the terminal plate 122 is located.

In an embodiment, the electrode assembly accommodated in the case 110 may be formed in a jelly-roll shape by winding a first electrode 210, a separator 230 disposed on the first electrode 210, and a second electrode 220 disposed on the separator 230 around a core part. For example, the wound-type electrode assembly may be formed by tightly winding sheet-shaped positive and negative electrodes into a cylindrical or elliptical structure in cross-section. Referring to FIG. 1, the lengths in the width direction of the first electrode 210, the second electrode 220, and the separator 230 are illustrated as being the same in FIG. 1, but this is a simplified schematic representation of the electrode assembly and a width of any one of the first electrode 210, the second electrode 220, and the separator 230 may be larger than a width of another component.

The first electrode 210 may include a first substrate layer and a first active material layer located on the first substrate layer. A first electrode tab 212 or a first lead tab may extend outward from a blank (e.g., uncoated) portion where the first active material layer is not located on the first substrate layer. The first electrode tab 212 or the first lead tab may be electrically connected to the cap assembly 120. Specifically, the first electrode tab 212 or the first lead tab may be electrically connected to the terminal plate 122. In this case, the terminal plate 122 may protrude outside the secondary battery 100 and may function as a first electrode terminal.

The second electrode 220 may include a second substrate layer and a second active material layer located on the second substrate layer. A second electrode tab 222 or a second lead tab may extend outward from a second blank portion where the second active material layer is not located on the second substrate layer. The second electrode tab 222 or the second lead tab may be electrically connected to the case 110. In this situation, the case 110 may function as a second electrode terminal.

As shown in FIG. 1, the first electrode tab 212 and the second electrode tab 222 in the electrode assembly may extend in directions opposite to each other. In other embodiments, the first lead tab and the second lead tab in the electrode assembly may extend in the same direction.

The first electrode 210 may function as a positive electrode. In this case, the first substrate may be a positive-electrode substrate. The positive-electrode substrate may be formed of an aluminum foil, and the positive-electrode active material may include, for example, a transition-metal oxide. The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used. The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α}(0.90≤a≤1.8, 0≤b≤0.5, 0≤c≤0.5, and 0<α<2); LiₐNi_{1-b-c}Mn_{b}X_{c}O_{2-α}D_{α}(0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The second electrode 220 may function as a negative electrode. In this case, the second substrate may be a negative-electrode substrate. The negative-electrode substrate may be formed of, for example, a copper foil or a nickel foil, and the negative-electrode active material may include, for example, graphite. The negative electrode active material may include a material that reversibly intercalates/deintercalates lithium ions, a lithium metal, a lithium metal alloy, a material capable of doping/dedoping lithium, or a transition metal oxide. The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO₂, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The separator 230 functions in a lithium secondary battery to allow movement of lithium ions while preventing a short circuit between the first electrode 210 and the second electrode 220. The separator 230 may include polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like. The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer. The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

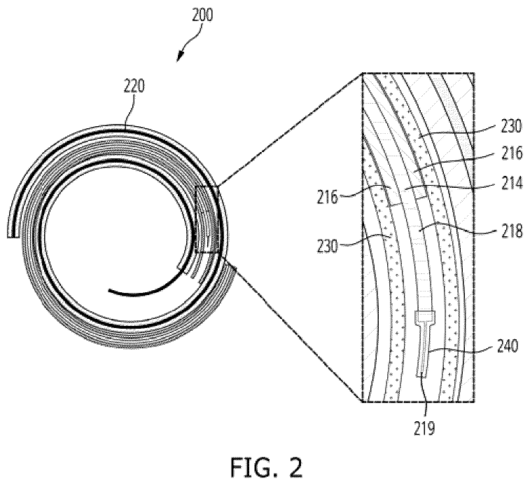

In an embodiment, the electrode assembly 200 (see FIG. 2) may further include a sealing tape that wraps at least a portion of an outermost periphery of the electrode assembly 200. Here, the sealing tape may seal the electrode assembly 200 that is wound. For example, winding of the first electrode 210, the second electrode 220, and the separator 230 in the electrode assembly 200 may be maintained without being unwound by the sealing tape. For example, the sealing tape may have adhesiveness and may be coupled with at least a portion of the outermost periphery of the electrode assembly 200. The sealing tape may include an insulating material. For example, the sealing tape may include at least one of PI (polyimide), PE (polyethylene), and PS (polystyrene).

FIG. 2 illustrates a state after winding of the electrode assembly 200 according to an embodiment of the present disclosure. Although the first electrode 210, the second electrode 220, and the separator 230 are in close contact with one another in the electrode assembly 200, these components are illustrated as being spaced apart from one another in FIG. 2 for ease of understanding of the present disclosure.

Referring to FIG. 2, the electrode assembly 200 may include the first electrode 210, the second electrode 220, and the separator 230 disposed between the first electrode 210 and the second electrode 220. Here, the first electrode 210 may include a first substrate layer 214 and a first active material layer 216 coated on both surfaces (e.g., opposite surfaces) of the first substrate layer 214. In addition, the second electrode 220 may include a second substrate layer and a second active material layer coated on both surfaces (e.g., opposite surfaces) of the second substrate layer.

According to an embodiment, the first electrode 210, the separator 230, and the second electrode 220 may be sequentially stacked and wound. For example, in a state in which the electrode assembly 200 is wound, the second electrode 220 may be located closer to the core part than the first electrode 210. According to an embodiment, the separator 230 may be disposed on the second electrode 220 around the core part, and the first electrode 210 may be disposed on the separator 230.

In a state in which the first electrode 210 is wound, a leading portion 218 of the first electrode 210 may be located at the core part of the electrode assembly 200. Conversely, in a state in which the first electrode 210 is wound, a trailing portion of the first electrode 210 may be located at an outer periphery of the electrode assembly 200. For example, in a state before winding of the first electrode 210, the leading portion 218 and the trailing portion of the first electrode 210 may be located in opposite directions in a longitudinal direction of the first electrode 210.

A thickness of a tip end 219 of the leading portion 218 of the first electrode 210 may be thinner than a thickness of a portion of the leading portion 218 other than the tip end 219. According to an embodiment, in a state in which the first electrode 210 is wound, a thickness of the tip end 219 of the leading portion 218 of the first electrode 210 formed at the core part may be thinner than a thickness of a portion of the first electrode 210 other than the tip end 219 of the leading portion 218. For example, the thickness of the leading portion 218 may decrease toward the tip end 219 at an arbitrary point on a blank portion, and the thickness of the tip end 219 of the leading portion 218 may be a constant thickness. However, the leading portion 218 may be formed in a shape gradually thinning toward the tip end 219. According to an embodiment, a step may be formed between the tip end 219 of the leading portion 218 of the first electrode 210 and a portion of the first electrode 210 other than the tip end 219. For example, steps may be formed on both surfaces of the leading portion 218. According to another embodiment, only one surface of the tip end 219 of the leading portion 218 of the first electrode 210 may be formed to be thin, and the other surface may remain flat without a step, so that only one surface of the leading portion 218 has a step. Here, an edge of the step formed at the leading portion 218 of the first electrode 210 may be formed to be rounded.

The electrode assembly 200 may further include a protective tape 240 disposed on the tip end 219 of the leading portion 218 of the first electrode 210. For example, the protective tape 240 may be formed so as to wrap at least a portion of the tip end 219 of the leading portion 218 in a direction perpendicular to a longitudinal direction of the first electrode 210. According to an embodiment, the protective tape 240 may be attached to the tip end 219 of the leading portion 218 of the first electrode 210 and a portion of the leading portion 218 adjacent to the tip end 219. For example, the protective tape 240 may be attached together to the tip end 219 of the leading portion 218 and a portion of the first electrode 210 other than the tip end 219 of the leading portion 218 so as to cover the step formed at the leading portion 218.

According to an embodiment, the protective tape 240 may be attached not only in a vertical direction to the tip end 219 of the leading portion 218 of the first electrode 210 but also in a horizontal direction. For example, the protective tape 240 may be attached in vertical and horizontal directions with respect to a longitudinal direction of the first electrode 210 so that the tip end 219 of the leading portion 218 is not exposed to the outside. With this configuration, burrs generated during cutting of the substrate can be reduced, and damage to the separator 230 caused by slip of the positive-electrode substrate can be prevented.

According to an embodiment, a tip end 219 of a leading portion 218 of the first electrode 210 may be formed by rolling or pressing a rectangular electrode plate extending in a lengthwise direction and then cutting the electrode plate. For example, a thickness of the tip end 219 of the leading portion 218 formed in a core part by a press-and-cutting process may be thinner than a thickness of a portion of the first electrode 210 excluding the tip end 219 of the leading portion 218. According to an embodiment, a step may be formed between the tip end 219 of the leading portion 218 of the first electrode 210 formed by the pressing process and a portion of the first electrode 210 excluding the tip end 219 of the leading portion 218. For example, steps may be formed on both surfaces of the leading portion 218 by the pressing process performed in upward and downward directions perpendicular to one surface of the first electrode 210. In another embodiment, only one surface of the tip end 219 of the leading portion 218 of the first electrode 210 may be thinned by the pressing process performed in one direction perpendicular to one surface of the first electrode 210, while the other surface remains as it is so that only one surface of the leading portion 218 has the step. An edge of the step formed on the leading portion 218 by the pressing process may be rounded.

At least a part of a first substrate layer 214 of the first electrode 210 may include a non-coated portion where a first active material layer 216 is not coated. At least a part of a second substrate layer of the second electrode 220 may include a non-coated portion where a second active material layer is not coated. For example, the tip end 219 of the leading portion 218 of the first substrate layer 214 may include the non-coated portion where the first active material layer 216 is not applied.

According to an embodiment, a thickness of the tip end 219 of the leading portion 218 of the first substrate layer 214 having the blank portion may be thinner than a thickness of a portion of the first substrate layer 214 where the blank portion is not formed. For example, a region in which a step is formed on the leading portion 218 of the first electrode 210 may correspond to a region where the blank portion is formed. According to an embodiment, a thickness of the tip end 219 of the blank portion on the leading portion 218 of the first electrode 210 may be thinner than a thickness of a portion of the blank portion excluding the tip end 219.

According to an embodiment, the electrode assembly may further include a protective tape 240 disposed on the tip end 219 of the leading portion 218 of the first substrate layer 214 having the non-coated portion. For example, the protective tape 240 may be formed to wrap the tip end 219 of the leading portion 218 of the first substrate layer 214 having the non-coated portion in a direction perpendicular to a lengthwise direction of the first electrode 210. According to an embodiment, the protective tape 240 may be disposed on the tip end 219 of the non-coated portion on the leading portion 218. For example, the protective tape 240 may be formed to wrap at least a part of the tip end 219 of the non-coated portion in a direction perpendicular to the lengthwise direction of the first electrode 210.

The separator 230 may extend from the leading portion 218 of the first electrode 210 and be exposed. Because the separator 230 is exposed, even if deformation of the electrode assembly 200 occurs during charging and discharging, contact between the first electrode 210 and the second electrode 220 may be prevented, thereby preventing a short circuit.

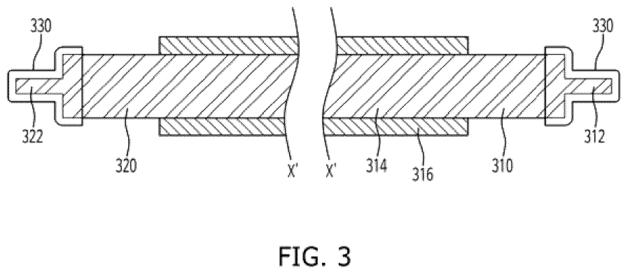

FIG. 3 illustrates a first electrode according to an embodiment of the present disclosure. FIG. 3 is a simplified drawing in which a middle portion of the first electrode is omitted by a break line X′.

Referring to FIG. 3, the first electrode may include a leading portion 310 and a trailing portion 320 opposite the leading portion 310. The leading portion 310 of the first electrode and a distal end 312 of the leading portion 310 are the same as described above with reference to FIG. 2, and redundant description is omitted.

A thickness of a distal end 322 of the trailing portion 320 of the first electrode may be thinner than a thickness of a portion of the trailing portion 320 excluding the distal end 322. According to an embodiment, a thickness of the distal end 322 of the trailing portion 320 of the first electrode formed in a core part in a state in which the first electrode is wound may be thinner than a thickness of a portion of the first electrode excluding the distal end 322 of the trailing portion 320. For example, as the distal end 322 of the trailing portion 320 is approached from an arbitrary point on a non-coated portion, the thickness of the trailing portion 320 may decrease, and the thickness of the distal end 322 of the trailing portion 320 may be constant. However, the trailing portion 320 may also be formed to gradually become thinner toward the distal end 322. According to an embodiment, a step may be formed between the distal end 322 of the trailing portion 320 of the first electrode and a portion of the first electrode excluding the distal end 322. For example, steps may be formed on both surfaces (top and bottom surfaces in the orientation shown) of the trailing portion 320. In another embodiment, only one surface of the distal end 322 of the trailing portion 320 may be thinned, while the other surface remains flat so that only one surface of the trailing portion 320 has the step. An edge of the step formed on the trailing portion 320 may be rounded.

The electrode assembly may further include a protective tape 330 disposed on each of the distal end 312 of the leading portion 310 and the distal end 322 of the trailing portion 320 of the first electrode. For example, the protective tape 330 may be formed to wrap at least a part of the distal end 322 of the trailing portion 320 in a direction perpendicular to the lengthwise direction of the first electrode. According to an embodiment, the protective tape 330 may be attached to the distal end 322 of the trailing portion 320 and the portion of the trailing portion 320 adjacent to the distal end 322. For example, the protective tape 330 may be attached together to the portion of the first electrode excluding the distal end 322 of the trailing portion 320 and leading portion 310 so as to include the step formed on the trailing portion 320.

According to an embodiment, the protective tape 330 may be attached not only in a direction perpendicular to the distal end 322 of the trailing portion 320 but also in a horizontal direction. For example, the protective tape 330 may be attached in both a direction perpendicular to the lengthwise direction of the first electrode and a horizontal direction so that the distal end 322 of the trailing portion 320 is not exposed to the outside. With this configuration, damage that may occur due to the trailing portion 320, for example cracks, may be prevented.

According to an embodiment, the distal end 322 of the trailing portion 320 of the first electrode may be formed by rolling or pressing a rectangular electrode plate extending in the lengthwise direction and then cutting the electrode plate. For example, a thickness of the distal end 322 of the trailing portion 320 formed in a core part of the first electrode by a press-and-cutting process may be thinner than a thickness of a portion of the first electrode excluding the distal end 322 of the trailing portion 320. According to an embodiment, a step may be formed between the distal end 322 of the trailing portion 320 of the first electrode formed by the pressing process and a portion of the first electrode excluding the distal end 322. For example, steps may be formed on both surfaces of the trailing portion 320 by the pressing process performed in upward and downward directions perpendicular to one surface of the first electrode. In another embodiment, only one surface of the distal end 322 of the trailing portion 320 may be thinned by the pressing process performed in one direction perpendicular to one surface of the first electrode, while the other surface remains flat so that only one surface of the trailing portion 320 has the step. An edge of the step formed on the trailing portion 320 by the pressing process may be rounded.

At least a part of a first substrate layer 314 of the first electrode may include a non-coated portion where a first active material layer 316 is not coated. At least a part of a second substrate layer of the second electrode may include a non-coated portion where a second active material layer is not coated. For example, the distal end 322 of the trailing portion 320 of the first substrate layer 314 may include the non-coated portion where the first active material layer 316 is not coated.

According to an embodiment, the thickness of the distal end 322 of the trailing portion 320 of the first substrate layer 314 where the non-coated portion is formed may be thinner than the thickness of a part of the first substrate layer 314 where the non-coated portion is not formed. For example, the region where a step is formed at the trailing portion 320 of the first electrode may correspond to the region where the non-coated portion is formed. According to an embodiment, the thickness of the distal end 322 of the non-coated portion on the trailing portion 320 of the first electrode may be thinner than the thickness of a part of the non-coated portion excluding the distal end 322.

According to an embodiment, the electrode assembly may further include a protective tape 330 disposed on the distal end 322 of the trailing portion 320 of the first substrate layer 314 having the non-coated portion. For example, the protective tape 330 may be formed to wrap the distal end 322 of the trailing portion 320 of the first substrate layer 314 having the non-coated portion in a direction perpendicular to the lengthwise direction of the first electrode. According to an embodiment, the protective tape 330 may be disposed on the distal end 322 of the non-coated portion on the trailing portion 320. For example, the protective tape 330 may be formed to wrap at least a part of the distal end 322 of the non-coated portion in a direction perpendicular to the lengthwise direction of the first electrode.

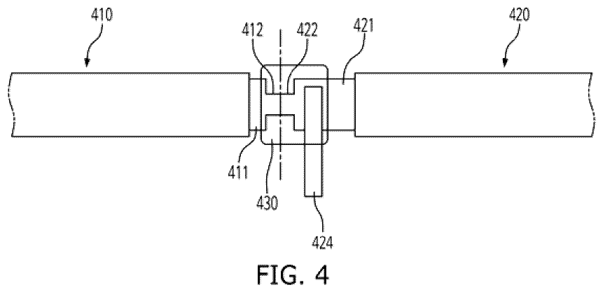

FIG. 4 illustrates a state before cutting of the first electrode according to an embodiment of the present disclosure. FIG. 4 shows a manufacturing process of the first electrode according to an embodiment; a first electrode 410 and a second electrode 420 may be formed by cutting between a first electrode 410 portion and a second electrode 420 portion included in a rectangular electrode plate.

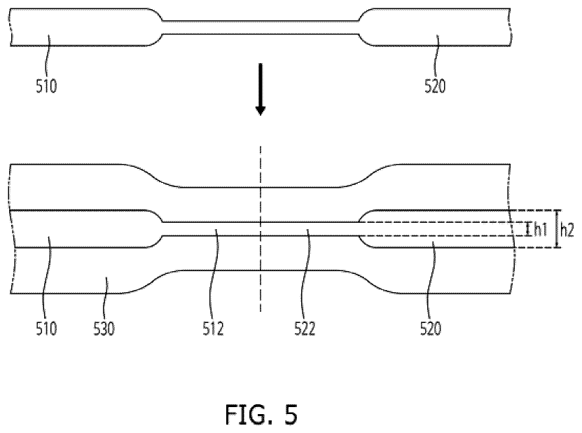

Referring to FIG. 4, a distal end 412 of a leading portion 411 of the first electrode 410 and a distal end 422 of a trailing portion 421 of the second electrode 420 may be manufactured in a connected state in the rectangular electrode plate. In addition, electrode 410 and electrode 420 may be manufactured by rolling, in a roll-to-roll process, an electrode plate in which the first electrode 410 and the second electrode 420 are formed as a single structure by a pressing process and then separating the electrode plate through cutting, as will be described below with reference to FIGS. 5 to 8. Although only the first electrode 410 and the second electrode 420 are illustrated in FIG. 4, additional electrodes, such as a third electrode and a fourth electrode, may be sequentially connected in the same manner in a continuous roll-to-roll process. The same applies to FIGS. 5 to 8 described below.

On the continuous electrode plate, the distal end 412 of the leading portion 411 of the first electrode 410 and the distal end 422 of the trailing portion 421 of the second electrode 420 may be formed to have the same thickness. According to an embodiment, a step may be formed between the leading portion 411 of the first electrode 410 and the trailing portion 421 of the second electrode 420 and portions excluding the leading portion 411 and the trailing portion 421. Steps formed on the first electrode 410 and the second electrode 420 may be rounded.

An electrode tab 424 may be attached to the trailing portion 421 of the second electrode 420 and, after the manufacturing process is completed, may serve as the first electrode tab 212 of FIG. 1. According to an embodiment, an electrode-tab protective tape may be attached to the electrode tab 424.

The leading portion 411 of the first electrode 410 and the trailing portion 421 of the second electrode 420 may include a protective tape 430. According to an embodiment, the protective tape 430 may be attached to the distal end 412 of the leading portion 411 and the distal end 422 of the trailing portion 421, and may also be attached together to regions of the leading portion 411 and the trailing portion 421 excluding the distal end 412 and distal end 422. According to an embodiment, the protective tape 430 may be attached to the leading portion 411 of the first electrode 410 and the trailing portion 421 of the second electrode 420, and may also be attached together to the electrode tab 424. This configuration may reduce a size of the substrate and prevent burr generation. However, a separate electrode-tab protective tape may be attached to the electrode tab 424.

In some embodiments, an electrode tab may also be formed on a trailing portion of the first electrode 410 in the same manner as the second electrode 420. The same applies to a thickness of a distal end of the trailing portion of the first electrode 410 and a distal end of a leading portion of the second electrode 420 and to the protective tape, as described above for the distal end 412 of the leading portion 411 of the first electrode 410 and the distal end 422 of the trailing portion 421 of the second electrode 420. The same applies to FIGS. 5 to 8 described below.

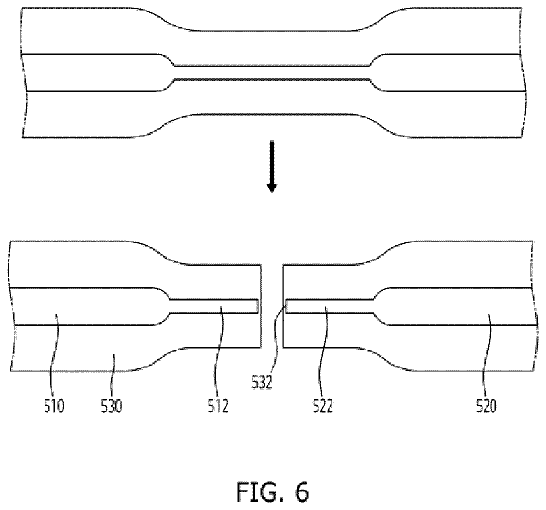

FIG. 5 illustrates a state before cutting of a leading portion 510 and a trailing portion 520 according to an embodiment of the present disclosure. FIG. 6 illustrates a state after cutting of the first electrode according to an embodiment of the present disclosure. The leading portion 510 and the trailing portion 520 of FIGS. 5 and 6 are exemplary embodiments of the leading portion 411 of the first electrode and the trailing portion 421 of the second electrode of FIG. 4, respectively.

Referring to FIG. 5, after pressing a distal end 512 of the leading portion 510 and a distal end 522 of the trailing portion 520 using a pressing process, a protective tape 530 may be attached to the distal end 512 of the leading portion 510 and the distal end 522 of the trailing portion 520. According to an embodiment, the protective tape 530 may be attached so as to include a region other than the pressed region. For example, the protective tape 530 may be attached to a non-coated portion of each of the first electrode and the second electrode. However, at least one of the distal end 512 of the leading portion 510 and the distal end 522 of the trailing portion 520 may be pressed, and at least one of the distal end 512 of the leading portion 510 and the distal end 522 of the trailing portion 520 may have the protective tape 530 attached. For example, only the leading portion 510 of the first electrode may be pressed excluding the trailing portion 520 of the second electrode, and only the protective tape 530 may be attached to the leading portion 510 of the first electrode excluding the trailing portion 520 of the second electrode.

A thickness h1 of each of the leading portion 510 and the trailing portion 520 may be the same, and a thickness h2 of each of the distal end 512 and distal end 522 may also be the same. According to an embodiment, the thickness h1 of each of the leading portion 510 and the trailing portion 520 may be formed to be 10μm to 15μm, and the thickness h2 of each of the distal end 512 and distal end 522 may be formed to be less than or equal to 6μm. By pressing each of the distal end 512 and distal end 522, a length in a horizontal direction of the first electrode and the second electrode may slightly increase, but an influence on an overall structure and performance of the electrode due to the length change may be small.

Referring to FIG. 6, the first electrode 210 of FIGS. 1 and 2 may be formed by cutting between the leading portion 510 and the trailing portion 520. According to an embodiment, during a process of cutting between the leading portion 510 and the trailing portion 520, the protective tape 530 attached may extend in a direction perpendicular to one surface of the first electrode due to pressure generated during the cutting process. With this configuration, cut surfaces 532 of each of the distal end 512 of the leading portion 510 and the distal end 522 of the trailing portion 520 may not be exposed to the outside, and the protective tape 530 may physically protect the cut surfaces 532.

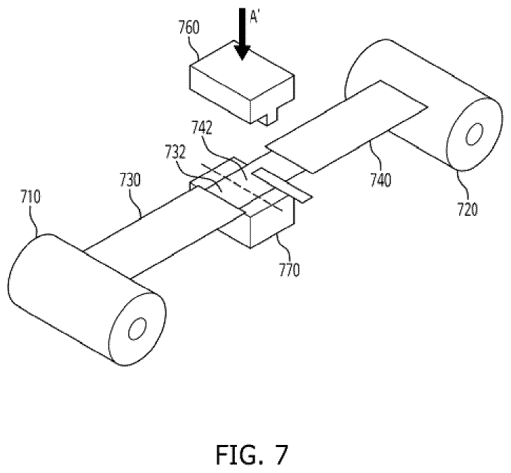

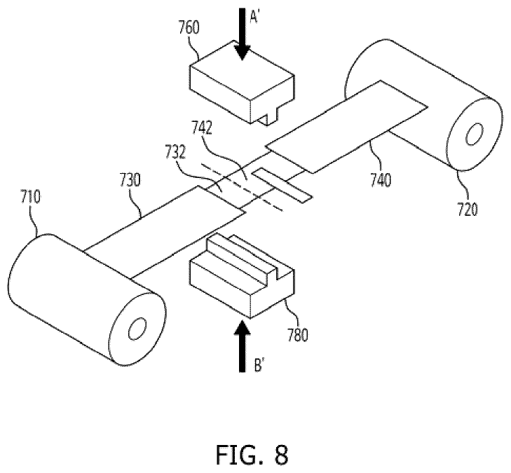

FIG. 7 is a diagram illustrating a pressing process of first electrode 730 and first electrode 740 (e.g., after being cut) according to an embodiment of the present disclosure. FIG. 8 is a diagram illustrating a pressing process of the first electrode 730 and first electrode 740 according to an embodiment of the present disclosure.

Referring to FIG. 7, the first electrode 730 and second electrode 740 may be provided in a state wound by rolls 710 and 720, respectively. The first electrode 730 and second electrode 740 may be conveyed in a conveying direction by a conveying roller or the like. The conveying direction may be the same as a lengthwise direction of the first electrode 730 and second electrode 740. In an embodiment, a first press unit 760 may press the first electrode 730 and second electrode 740 in a direction (e.g., an A′ direction) perpendicular to one surface of the first electrode 730 and second electrode 740. The first press unit 760 may press a distal end of a leading portion 732 of the first electrode 730 and a distal end of a trailing portion 742 of the second electrode 740.

The first electrode 730 and second electrode 740 may include a substrate layer and an active material layer coated on at least one surface of the substrate layer, and at least one of a distal end of a leading portion 732 of the substrate layer and a distal end of a trailing portion 742 of the substrate layer may include a non-coated portion where the active material layer is not coated. According to an embodiment, the first press unit 760 may descend in a direction perpendicular to one surface of the first electrode 730 and second electrode 740 and press the distal end of the non-coated portion, thereby performing a pressing process. For example, the distal end of each non-coated portion of the first electrode 730 and the second electrode 740 may be pressed.

In an embodiment, with reference to the first electrode 730 and first electrode 740, a support unit 770 may be included opposite the first press unit 760. The support unit 770 may be located below the first electrode 730 and first electrode 740 so that uniform pressure is conveyed throughout the entire substrate, thereby contributing to preventing meandering of the electrode plates. For example, the distal end of each of the leading portion 732 and the trailing portion 742 may be pressed in a downward direction (e.g., an A′ direction) perpendicular to one surface of the first electrode 730 and first electrode 740, and the support unit 770 may support the first electrode 730 and first electrode 740.

According to an embodiment, the first press unit 760 and the support unit 770 may form only one surface of each of the leading portion 732 and the trailing portion 742 to be thinner, while the other surface remains flat so that only one surface of each of the leading portion 732 and the trailing portion 742 has a step. Steps formed on the leading portion 732 and the trailing portion 742 may be rounded.

In an embodiment, after the first press unit 760 and the support unit 770 press the first electrode 730 and second electrode 740, a protective tape may be attached to the leading portion 732 and a trailing portion 734 of the first electrode 730 and second electrode 740. This is the same as described above with reference to FIGS. 2 to 6, and redundant description is omitted.

Referring to FIG. 8, the first press unit 760 and a second press unit 780 may press the first electrode 730 and second electrode 740 in a direction perpendicular to one surface of the first electrode 730 and second electrode 740. The first press unit 760 and the second press unit 780 may press a distal end of the leading portion 732 of the first electrode 730 and a distal end of the trailing portion 742 of the second electrode 740. According to an embodiment, the first press unit 760 may descend and the second press unit 780 may ascend in directions (e.g., an A′ direction and a B′ direction) perpendicular to one surface of the first electrode 730 and second electrode 740 and press the distal end of the non-coated portions, thereby performing a pressing process. For example, the distal end of each non-coated portion of the first electrode 730 and the second electrode 740 may be pressed.

According to an embodiment, a step may be formed between portions of the first electrode 730 and second electrode 740 excluding the distal end of each of the leading portion 732 and the trailing portion 742 by the first press unit 760 and the second press unit 780. Steps may be formed on both surfaces (e.g., top and bottom surfaces in the orientation shown) of the leading portion 732 and the trailing portion 742. Steps formed on the leading portion 732 and the trailing portion 742 may be rounded.

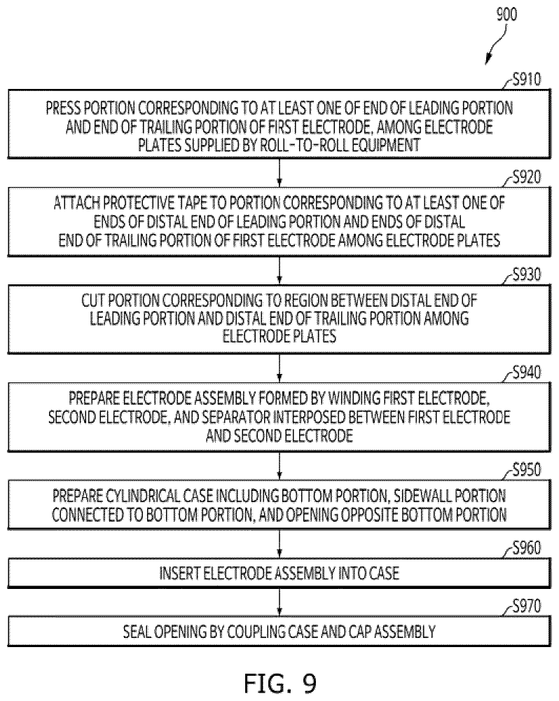

FIG. 9 illustrates an example of a method 900 for manufacturing a secondary battery according to an embodiment of the present disclosure.

Referring to FIG. 9, the method for manufacturing the secondary battery may include pressing a portion corresponding to at least one of the end of the leading portion and the end of the trailing portion of a first electrode, among electrode plates supplied by roll-to-roll equipment (S910). In step S910, at least one of the end of the leading portion and the end of the trailing portion may be pressed in a direction perpendicular to one surface of the first electrode to perform a pressing process.

According to an embodiment, the first electrode may include a substrate layer and an active material layer coated on at least one surface of the substrate layer. A non-coated portion where the active material layer is not coated may be formed at at least one end, either the distal end of the leading portion or the distal end of the trailing portion of the substrate layer. Here, the pressing process may be performed by pressing a distal end of the non-coated portion in a direction perpendicular to one surface of the first electrode.

Thereafter, a protective tape may be attached to a portion corresponding to at least one of the ends of the distal end of the leading portion and the ends of the distal end of the trailing portion of the first electrode among the electrode plates (S920). Here, at least one of the ends of the distal end of the leading portion and the ends of the distal end of the trailing portion may be wrapped in a direction perpendicular to the lengthwise direction of the first electrode with the protective tape.

After attaching the protective tape, a portion corresponding to a region between the distal end of the leading portion and the distal end of the trailing portion among the electrode plates may be cut (S930).

An electrode assembly formed by winding the first electrode, a second electrode, and a separator interposed between the first electrode and the second electrode may be prepared (S940).

Thereafter, a cylindrical case including a bottom portion, a sidewall portion connected to the bottom portion, and an opening opposite the bottom portion may be prepared (S950).

The electrode assembly may be inserted into the case (S960).

Then, the case and a cap assembly may be coupled to seal the opening (S970).

The flowchart of FIG. 9 and the above description are merely an example of the present disclosure, and the scope of the present disclosure is not limited to the flowchart of FIG. 9 and the above description. For example, one or more steps of the flowchart and the above description may be added, changed, or deleted; an order of one or more steps may be changed; or one or more steps may be performed simultaneously.

Insertion and extraction of lithium ions during charging and discharging of a secondary battery may cause expansion and contraction of the electrode plates, and, if deformation of the electrode assembly occurs, the positive electrode and the negative electrode may contact each other to cause a short circuit.

Meanwhile, along with trends toward miniaturization and thinning of electronic devices that use secondary batteries, studies on miniaturization and thinning of secondary batteries are actively being conducted. Increasing the volume of a secondary battery can increase the capacity of the battery; however, the increased volume is disadvantageous for application to small devices. Accordingly, there is an increasing need for technology capable of increasing the capacity of a secondary battery while maintaining or reducing the volume of the secondary battery.

According to some embodiments of the present disclosure, a thickness of a tip end of a leading portion of an electrode included in an electrode assembly of a secondary battery may be thinner than a thickness of a portion of the leading portion other than the tip end, and a protective tape may be disposed on the tip end of the leading portion of the electrode. With this configuration, burrs generated during cutting of the substrate of the electrode in a manufacturing process of the secondary battery can be reduced, and damage to a separator caused by slip of a positive-electrode substrate can be prevented.

According to some embodiments of the present disclosure, a thickness of a tip end of a trailing portion of an electrode may be thinner than a thickness of a portion of the trailing portion other than the tip end, and a protective tape may be disposed on the tip end of the trailing portion of the electrode. With this configuration, damage (e.g., cracks) that may occur in other components around the trailing portion of the electrode can be prevented.

According to some embodiments of the present disclosure, the protective tape may be attached to both the end portion of the electrode and an electrode tab. With this configuration, a size of the substrate can be reduced, and the generation of burrs can be prevented.

According to some embodiments of the present disclosure, in a process of cutting between the leading portion and the trailing portion of the electrode during the manufacturing process of the secondary battery, the protective tape that has been attached may extend in a direction perpendicular to a plane of the electrode due to pressure generated during the cutting process. With this configuration, cut surfaces of the tip end of the leading portion and the tip end of the trailing portion are not exposed to the outside, and the protective tape can physically protect the cut surfaces.

Although the present disclosure has been described above with respect to embodiments thereof, the present disclosure is not limited thereto. Various modifications and variations may be made by those skilled in the art within a spirit of the present disclosure and an equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a first electrode having a first electrode tab connected thereto;
a second electrode having a second electrode tab connected thereto; and
a separator between the first electrode and the second electrode,
wherein the first electrode, the separator, and the second electrode are sequentially stacked and wound, and wherein a thickness of a distal end of a leading end of the first electrode is thinner than a thickness of a portion of the first electrode excluding the distal end of the leading end, the distal end being in a core part when the first electrode is wound.

2. The electrode assembly as claimed in claim 1, further comprising a protective tape on the distal end of the leading end, wherein the protective tape wraps at least a part of the distal end of the leading end in a direction perpendicular to a lengthwise direction of the first electrode.

3. The electrode assembly as claimed in claim 1, wherein the distal end of the leading end is flattened.

4. The electrode assembly as claimed in claim 1, wherein a thickness of a distal end of a trailing end of the first electrode on an outer circumference of the electrode assembly is thinner than a thickness of a portion of the first electrode excluding the distal end of the trailing end.

5. The electrode assembly as claimed in claim 4, further comprising a protective tape on the distal end of the trailing end, wherein the protective tape wraps at least a part of the distal end of the trailing end in a direction perpendicular to a lengthwise direction of the first electrode.

6. The electrode assembly as claimed in claim 4, wherein the distal end of the trailing end is flattened.

7. The electrode assembly as claimed in claim 1, wherein the first electrode comprises:
a substrate layer and an active material layer coated on at least one surface of the substrate layer, and
a non-coated portion where the active material layer is not coated is at the distal end of the leading end of the substrate layer.

8. The electrode assembly as claimed in claim 7, wherein a thickness of the distal end of the leading end of the substrate layer having the non-coated portion is thinner than a thickness of a portion of the substrate layer other than the non-coated portion.

9. The electrode assembly as claimed in claim 7, further comprising a protective tape on the distal end of the leading end of the substrate layer having the non-coated portion, wherein the protective tape wraps the distal end of the leading end of the substrate layer having the non-coated portion in a direction perpendicular to a lengthwise direction of the first electrode.

10. The electrode assembly as claimed in claim 4, wherein the first electrode comprises:
a substrate layer and an active material layer coated on at least one surface of the substrate layer, and
a non-coated portion where the active material layer is not coated is at the distal end of the trailing end of the substrate layer.

11. The electrode assembly as claimed in claim 10, wherein a thickness of the distal end of the trailing end of the substrate layer having the non-coated portion is thinner than a thickness of a portion of the substrate layer other than the non-coated portion.

12. The electrode assembly as claimed in claim 10, further comprising a protective tape at the distal end of the trailing end of the substrate layer where the non-coated portion is formed, wherein the protective tape wraps around the distal end of the trailing end of the substrate layer with the non-coated portion in a direction perpendicular to a lengthwise direction of the first electrode.

13. A secondary battery, comprising:
an electrode assembly having a winding of a first electrode, a second electrode, and a separator between the first electrode and the second electrode;
a cylindrical case including a bottom portion, a sidewall portion connected to the bottom portion, and an opening opposite the bottom portion, the cylindrical case accommodating the electrode assembly; and
a cap assembly coupled to one end of the sidewall portion of the case to seal the opening,
wherein a thickness of a distal end of a leading end of the first electrode in a core part of the electrode assembly in a state in which the electrode assembly is wound is thinner than a thickness of a portion of the first electrode excluding the distal end of the leading end.

14. The secondary battery as claimed in claim 13, wherein a thickness of a distal end of a trailing end of the first electrode on an outer circumference of the electrode assembly is thinner than a thickness of a portion of the first electrode excluding the distal end of the trailing end.

15. The secondary battery as claimed in claim 14, further comprising a protective tape on at least one of the distal end of the leading end and the distal end of the trailing end, wherein the protective tape wraps at least one of the distal end of the leading end and the distal end of the trailing end in a direction perpendicular to a lengthwise direction of the first electrode.

16. The secondary battery as claimed in claim 14, wherein:
the first electrode comprises a substrate layer and an active material layer coated on at least one surface of the substrate layer,
at least one of the distal end of the leading end and the distal end of the trailing end of the substrate layer comprises a non-coated portion where the active material layer is not coated, and
a thickness of at least one of the distal end of the leading end and the distal end of the trailing end of the substrate layer having the non-coated portion is thinner than a thickness of a portion of the substrate layer other than the non-coated portion.

17. A method for manufacturing a secondary battery, the method comprising:
pressing, among electrode plates supplied by roll-to-roll equipment, a portion corresponding to at least one of a distal end of a leading end and a distal end of a trailing end of a first electrode;
attaching a protective tape to at least one of the distal end of the leading end and the distal end of the trailing end among the electrode plates;
cutting, among the electrode plates, a portion corresponding to a region between the distal end of the leading end and the distal end of the trailing end;
preparing an electrode assembly formed by winding the first electrode, a second electrode, and a separator interposed between the first electrode and the second electrode;
preparing a cylindrical case comprising a bottom portion, a sidewall portion connected to the bottom portion, and an opening opposite the bottom portion;
inserting the electrode assembly into the case; and
coupling the case and a cap assembly to seal the opening.

18. The method for manufacturing a secondary battery as claimed in claim 17, wherein the pressing comprises pressing at least one of the distal end of the leading end and the distal end of the trailing end in a direction perpendicular to one surface of the first electrode.

19. The method for manufacturing a secondary battery as claimed in claim 17, wherein the attaching comprises wrapping the protective tape around at least one of the distal end of the leading end and the distal end of the trailing end in a direction perpendicular to a lengthwise direction of the first electrode.

20. The method for manufacturing a secondary battery as claimed in claim 17, wherein:
the first electrode comprises a substrate layer and an active material layer coated on at least one surface of the substrate layer,
at least one of the distal end of the leading end and the distal end of the trailing end of the substrate layer comprises a non-coated portion where the active material layer is not coated, and
the pressing comprises pressing a distal end of the non-coated portion in a direction perpendicular to one surface of the first electrode.
